(19) United States
(12) Patent Application Publication
(10) Pub. No.: US 2004/0089533 A1
(43) Pub. Date: May 13, 2004

(54) Hydrogel coatings and their employment in a Quartz Crystal Microbalance ion sensor

(76) Inventors: David Alan Hoagland, Granby, MA (US); Douglas Warren Howie JR., Parkersburg, WV (US)

Correspondence Address: Law Office of William B. Ritchie, 43 Jackson Street, Concord, NH, 03301, US

(21) Appl. No.: 10/635,289

(22) Filed: Aug. 6, 2003

Related U.S. Application Data
(60) Provisional application No. 60/401,660, filed on Aug. 6, 2002.

(51) Int. Cl. B05D 1/40; B05D 3/02

(52) U.S. Cl. 204/192.11; 427/331

(57) ABSTRACT

A method to attach hydrophilic and/or ionogenic coatings to metallic surfaces robustly. Important applications for the invention extend to sensor types, various biomedical devices, and additional technologies requiring metal coatings with specified properties, such as sensors that employ the Quartz Crystal Microbalance (QCM) principle. This is a method to produce an adherent hydrogel against a metal surface by gelling a liquid mixture of components. The implementation of the invention for QCM ion sensors employs poly(allylamine) (PAH) hydrogels. The reaction of PAH with N-Acetylhomocysteine thiolactone (AHTL) (Fluda) in water under basic conditions produces thiol groups. This reaction removes ion exchange functionality and permits robust attachment of the hydrogel to the QCM's gold electrode. The PAH concentration in the aqueous starting mixture is between 12 and 25 weight percent, the AHTL concentration is between 5 and 25 mole percent of PAH repeat units, and the DadMac concentration is between 10 and 15 mole percent of PAH repeat units. Also, between 1 and 2 equivalents of base (sodium, hydroxide, NaOH) are present per equivalent of PAH repeat units.

This application claims benefit of priority under 35 U.S.C. §119(e) to U.S. Provisional Application Serial No. 60/401,660 filed on Aug. 6, 2002.

### BACKGROUND OF INVENTION

1. Field of the Invention

The present invention generally relates to attaching hydrophilic and/or ionogenic coatings to metallic surfaces robustly. Important applications for the invention are sensors that employ the Quartz Crystal Microbalance (QCM) principle, but applications extend to other sensor types, various biomedical devices, and additional technologies requiring metal coatings with specified properties.

2. Description of the Related Art

The potential of QCM sensors for detecting substances present at low concentrations in liquids has sparked much activity in both the patent and research literatures. To achieve high sensitivity and high selectivity to a targeted substance, the QCM's active area (that in contact with the liquid) must normally be coated with a functional layer that complexes or adsorbs the substance. Sensitivity is defined in terms of the lowest concentration of a substance that can be detected, and selectivity is defined as the ability to distinguish one substance in the presence of similar substances. In a thickness shear mode QCM device, the active area is a metal electrode. Various QCM coatings have been discussed in the literature, including cross-linked films that have been molecularly imprinted, self-assembled monolayers that anchor chemical functionality, and physically adhered solid films that host similar functionality. Most often, the coating has been applied to enhance detection of specific organic or biological molecules. Films with ion exchange functionality have been described in a few instances, but not those that might facilitate detection of small ions by their complexation or adsorption. Also, uncoated QCMs able to detect contaminants that spontaneously adsorb to the electrode surface have been reported, as have uncoated QCMs able to detect ions in solution via field-ion interactions (acousto-electric effect). When sensitive and selective to a liquid contaminant, QCM sensors are competitive with other sensor types in terms of cost, speed of response, physical size, and other measures of practical performance.

Ion-exchanging hydrogels are particularly attractive as coatings for QCM sensors targeting small ions in solution. Ion exchange is the process by which ions are exchanged between a solution and an insoluble phase. In general, the insoluble phase, or ion exchange medium, contains fixed ionic sites of charge opposite to the exchangeable ions. Charges of the ionic sites are neutralized by the reversible binding of exchangeable ions of opposite charge; the exchangeable ions are thus referred to as counterions. The exchange of counterions between solution and insoluble phase occurs so that the net charge of the insoluble phase remains constant. The total charge of the ions that can be exchanged from solution equals to the total charge of all ionic sites of the ion exchange medium, defining the medium's ion exchange capacity. Different counterions have different affinities for the fixed ionic sites of the ion exchange medium, defining an affinity sequence. At equal concentration, a counterion species that is more strongly bound will displace from the ion exchange medium a counterion species that is less strongly bound. This exchange releases the less strongly bound species into solution.

An ion exchange medium with positive charged fixed sites can exchange anions (negative ions), so this type of medium is termed an anion exchange medium. An ion exchange medium with negative fixed sites can exchange cations (positive ions), so this type of medium is termed a cation exchange medium. Typical anion exchangers contain protonated or quaternary amine functionalities. Typical cation exchangers contain functionalities such as sulfonate, sulfate, phosphate, or carboxylate.

A QCM sensor coated with an ion-exchanging hydrogel will change mass as counterions are exchanged, if as usually is the case, these counterions vary in molar mass. This mass change causes a detectable change in the QCM resonant frequency. The mass change for an ideal QCM ion sensor roughly tracks the ion-exchange capacity of the coating on the QCM's surface. Thus, a coating with high capacity is needed to make an ion sensor with high sensitivity. The sensor's selectivity, on the other hand, will reflect the affinity sequence of the hydrogel. This sequence is a function of the hydrogel's chemistry as well as of solution conditions. The best QCM ion sensor possesses a coating that endows both high sensitivity and high affinity to the target ion.

Numerous obstacles to the practical use of QCM sensors, including highly undesirable delamination/debonding of the functional coating from the QCM's electrodes, usually made of gold, are known. Gold, like other metals from the coinage family, has hydrophobic surfaces, not liking aqueous environments or hydrophilic materials. Due to the fact that the interfacial energy for a hydrophilic coating in intimate contact with hydrophobic surface is large, spontaneous delamination/debonding is expected when a hydrophilic coating is physically deposited on an unmediated (bare) metal surface. Also, most hydrophilic materials swell in contact with water, producing interfacial mechanical stresses that enhance the likelihood of the debonding/delamination.

For further background in the operation of QCM ion sensors, see “Quartz Crystal Microbalance (QCM)-Based Ion Sensors” by the present inventors, in Polymer Preprints 2001, 42(2), 619, which is the preprint for a talk of the same title presented to the Polymer Division of the American Chemical Society at their National meeting in Chicago, the entire preprint is incorporated herein by reference. One of the most important uses of the invention lies within the field of water quality determination, and more specifically, on-line sensors for that purpose. To date, coated QCM sensors have not been applied in this field except as described in U.S. Pat. No. 5,990,648. A broadly practical on-line sensor for harmful ions would have great commercial and societal impact, inasmuch as many of the most harmful contaminants of water are dissolved as ions. The U.S. Environmental Protection Agency establishes guidelines for the concentrations of these ions permitted in drinking water and allowed in industrial effluents. These levels generally range from parts-per-billion to parts-per-million. The list of regulated contaminants found in water as ions includes nitrate, nitrite, mercury, lead, arsenic, copper, chromium, cadmium, and many others. Currently, testing for these ions is done nearly exclusively by wet chemistry or chromatographic methods that are slow, expensive, error prone, and labor intensive. The few possible on-line methods (ion selective electrodes, conductivity) have problems associated with sensitivity, selectivity, interferences, and robustness. Because of these problems, the Environmental Protection Agency rarely permits testing of drinking water or industrial effluents by these methods, and even then, only for a handful of the least toxic ion types. In the absence of on-line sensors, most water quality determinations entail batch tests in off-site laboratories that may not return results for several days.

Arsenic contamination of drinking water is an example of the type of problems that a QCM ion sensor might address According to a Year 2000 World Health Organization press release, arsenic contamination of drinking water in Bangladesh is a “catastrophe on a vast scale,” affecting between 35 and 77 million people of the country's total population of 125 million. At least 100,000 cases of debilitating skin lesions are believed to have already occurred. Similar arsenic contamination of ground water has been found in many other countries, including the United States. Technologies for removal of arsenic are available, but on-line methods for monitoring the efficacy of these technologies are absent and desperately needed.

While the invention discloses several methods for endowing ion-exchange functionality to QCM ion sensors, the same methods more generally can facilitate robust attachment of polymeric hydrogels to metal surfaces for other purposes. The methods produce a “chemisorbed” as opposed to a “physisorbed” hydrogel layer. A chemisorbed layer has specific chemical interactions with a surface that approach the strength of a chemical bond. A physisorbed layer, on the other hand, has only nonspecific, van der Waals-type interactions with such a surface, and the strengths of these weaker interactions are more comparable to those that cause a gas to condense into a liquid. A physisorbed layer readily desorbs/debonds from a surface while a chemisorbed layer usually does not. Thus, in many applications, a physisorbed layer is less desirable. In addition, as noted earlier, most hydrogels will not form a stable physisorbed layer on the hydrophobic surfaces of coinage metals. Important applications of the disclosed invention are envisaged in biomedical devices that contact hydrogels with metals, electrochemical sensors requiring permeable coatings, and electrochemical actuators exploiting the volume change of hydrogels to do mechanical work. This list is not comprehensive.

There is not found in the prior art a successful method for forming adherent hydrogels on metals or for using such hydrogels to detect ions as part of a QCM sensor. By using ion-exchanging hydrogels in a QCM sensor, ions such as nitrates, phosphates, arsenic, chromium, copper, and organic or heavy metal contaminants may be detected. The same sensing strategy applies to gels that ion exchange/capture cations or those that capture ions by binding mechanisms other than ion exchange. Targets may include cations and anions, including species formed by complexation.

### BRIEF DESCRIPTION OF THE DRAWINGS

FIG. 1 is the chemical reaction responsible for the thiolation of poly(allylamine) by treatment with N-acetyl homocysteine thiolactone.

FIG. 2 is the chemical reaction responsible for the alkylation and crosslinking of poly(allylamine) by diallyldimethyl ammonium chloride.

FIG. 3 is a graph showing representative frequency response of a thiolated poly(allylamine) QCM sensor made in accordance with the invention. In this experiment, the sensor is repetitively challenged in its chloride form by four-hour exposures to aqueous solutions containing 5 millimolar nitrate (mM) (indicated on the figure by the label “LINO3 5e-3”, reflecting nitrate present in the form of its dissolved lithium salt). With each challenge, the resonant frequency of the sensor drops by approximately 1500 Hz, corresponding to conversion of the sensor to its nitrate form. The drop is reversed in each case when the challenging nitrate solution is withdrawn, being replaced by a solution containing 5 mM chloride (indicated on the figure by the label “KCL 5e-3”, reflecting chloride present in the form of its dissolved potassium salt).

FIG. 4 is the chemical reaction responsible for the thiolation of poly(vinyl alcohol) by treatment with thiourea.

FIG. 5 is the chemical reaction responsible for the thiolation of poly(vinyl alcohol) by treatment with thioacetate.

FIG. 6 is the chemical reaction responsible for the proposed thiolation of poly(allylamine) by ethylene sulfide. Other cyclic sulfides may be used in place of ethylene sulfide.

FIG. 7 is the chemical reaction responsible for the alkylation of poly(allylamine) by organic halides. “R” designates a linear or branched alkyl unit that may contain additional chemical functionality. The chemical structure of R can be manipulated to enhance ion specificity. The aklylation converts the primary amine to a secondary, tertiary, or quarternary amine depending on the number of R units attached to the nitrogen.

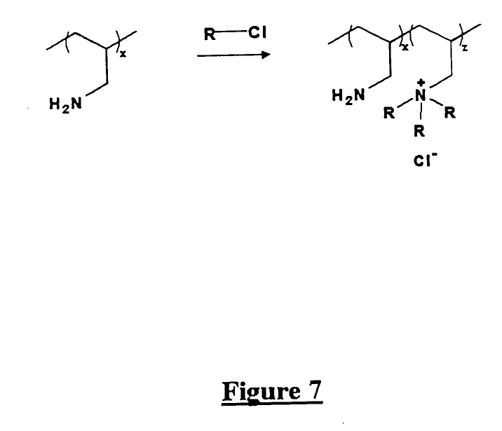

FIG. 8 is a representation of several chemical reactions that can be employed to protect the thiol group during liquid-state processing of thiol-containing polymers.

FIG. 9 is a representation of the adsorbed layers form by two different mercapto acids.

### DETAILED DESCRIPTION OF THE INVENTION

The invention discloses general methods for forming water-swollen hydrogels strongly adherent to metals as well as the application of such hydrogels to make QCM sensors that monitor for the presence and concentration of small ions in liquids. The substances that may be detected by said sensors include simple anions such as chloride and bromide, oxyanions such nitrates, phosphates, and arsenates, and simple or complexed metals ions formed by elements such as chromium, lead copper, cadmium, arsenic, mercury, and the like. Indeed, the sensors disclosed here likely are suitable for all aqueous ions. Many different adherent hydrogels can be created by the methods described, and when incorporated into a QCM sensor, this flexibility plays an important role, allowing ion specificity to be tuned according to the chemical functionalities incorporated within the hydrogel. Chemical functionalities in the hydrogel may be chosen so that QCM sensors operate via ion exchange, chelation, complexation or any combination thereof. Applications extend beyond QCM sensors to include all situations where a hydrogel film is formed in contact with a metal surface and must adhere robustly.

In its broadest sense, our invention is a method for producing an adherent hydrogel against a metal surface by gelling a liquid mixture of components. Gelling creates a three-dimensional chemical or physical network that transforms the mixture into a solid. A chemical network interconnects base polymer or monomer through covalent bonds, while a physical network interconnects base polymer or monomer through strong noncovalent interactions such as hydrogen bonding or van der Waals interactions. In addition to the base polymer or monomer that will comprise the hydrogel network, the mixture may include constituents that promote or cause gelling and constituents that promote or cause chemisorption of the network to the metal surface. Chemisorption entails the formation of specific bonds to the surface. A key element of the invention is concurrent formation of these bonds as the hydrogel network itself forms. In this manner, the tendency of a hydrogel to delaminate from a metal surface to which it is attached can be sharply minimized if not altogether eliminated. In many applications, it is desired to include in the liquid mixture constituents that copolymerize or otherwise react to endow the hydrogel with functional properties such as ion exchange.

Preferred Embodiment: Thiol-Functionalized Ion-Exchanging Hydrogels:

Strongly adherent, ion-exchanging hydrogels provide homogenous coatings enabling a new class of QCM ion sensors. A high density of fixed ionic sites can be placed in a homogeneous hydrogel, enhancing sensor sensitivity. In addition, the ionic sites are readily accessed by counterions in a liquid contacting the coating, enhancing sensor response time. Further, the thickness of a homogenous hydrogel coating can be readily altered and controlled. Coating thickness is observed to affect QCM response strongly. Appropriately prepared homogenous hydrogels are chemically and mechanically stable in most aqueous environments to which ion sensors are exposed. Lastly, homogenous hydrogels mechanically couple well to the QCM electrode, a feature important to shear wave propagation, a key element of successful QCM operation.

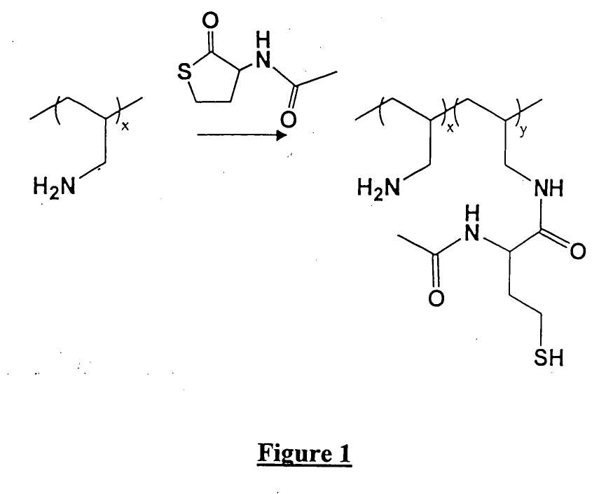

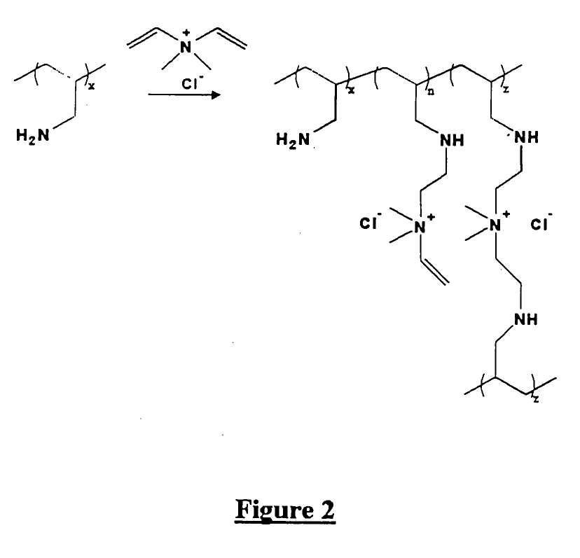

The preferred implementation of the invention for QCM ion sensors employs poly(allylamine) (PAH) hydrogels. Suitable PAH is available from commercial sources such as the Aldrich Chemical Company, and the implementation is not unduly sensitive to the properties (molecular weight, branching, etc.) or purity of this material. PAH contains nitrogen as primary amines that are protonated in water below pH 9. These protonated amines are well known to act as ion-exchange sites, and thus PAH hydrogels are anion exchangers below pH 9. The reaction of PAH with N-acetylhomocysteine thiolactone (AHTL) (Fluka) in water under basic conditions produces thiol groups, as shown in FIG. 1. High levels of thiolation, defined as the percentage of the original PAH repeat units that are thiolated, are not particularly desired via the reaction of FIG. 1, since this reaction removes ion exchange functionality. Fortunately, even low levels of thiolation permit robust attachment of the hydrogel to the QCM's gold electrode. For the range of reaction conditions examined (corresponding to yields for the reaction shown in FIG. 1 of about 50%), thiolation levels remain between 2.5 and 12.5%. Viable sensors have been produced across this range. Crosslinks are concurrently formed by the alkylation of PAH with diallyldimethyl ammonium chloride (DadMac) (Aldrich) as shown in FIG. 2. As the layer forms on the metal QCM surface, thiolation, crosslinking, and attachment occur together, at rates that depend principally on the concentrations of constituents and temperature. In preferred implementations, the PAH concentration in the aqueous starting mixture is between 12 and 25 weight percent, the AHTL concentration is between 5 and 25 mole percent of PAH repeat units, and the DadMac concentration is between 10 and 15 mole percent of PAH repeat units. Also, between 1 and 2 equivalents of base (sodium, hydroxide, NaOH) are present per equivalent of PAH repeat units. Other constituents in the aqueous mixture may be present but are not necessary.

In the preferred embodiment, the components described in the previous paragraph are mixed as follows: (1) the PAH is added to a solution of the NaOH and DadMac in water, (2) the AHTL is dissolved in a small volume of water, and (3) the solution of step 2 is rapidly added to the solution of step 1. The liquid mixture resulting from step 3 is immediately spun onto the QCM surface using a spin coater that rotates the QCM at 2000-3000 RPM. The delay between mixing and spinning should be less than 1 hr. The liquid-coated QCM is placed in an oven at temperature 120° C. for between 4 and 18 hrs, after which the QCM element is ready for use in a sensor. The best adhesion can be achieved by then removing that portion of the hydrogel coating that does hot cover the QCM electrode by razor, but this step provides only a minor advantage. After rinsing with water or NaCl solution, no special precautions are needed to store a hydrogel-coated QCM in air for long periods. When submerged in water, coatings made by the preferred embodiment remain well adhered and viable in sensor applications for a period exceeding two months.

In an alternative embodiment, bisacrylamide is employed in place of DadMac to crosslink PAH. However, side reactions (yellowing) in the hydrogel coating are much less significant when DadMac is used. Indeed, any crosslinking reagent having multiple double bonds could potentially be effective in place of DadMac. A distinct advantage of DadMac over most crosslinking agents is that ion-exchange sites are not diluted or lost in crosslinking as, for example, occurs with amidation, a more common crosslinking chemistry for amine-containing polymers. The hydrolytic stability of the formed crosslinks is also considerable greater than with amidation. Epoxide-type crosslinking agents themselves suffer from hydrolytic instability that discourages their use. Finally, DadMac and other allylamines have the crucial practical advantage of high water-solubility. In the preferred emodiment, with all reagents being water-soluble, gels can be thiolated and crosslinked by spinning films directly from aqueous solution.

### EXAMPLE

Preparation of a PAH QCM Ion Sensor:

1. A commercially available (Aldrich) aqueous solution of DadMac was diluted with sufficient reverse osmosis (RO) water to yield a 2.0 milliliter solution which was 0.135 molar in DadMac.

2. NaOH and PAH were added to the diluted DadMac solution of step 1 to produce an aqueous solution that was 2.7 molar in NaOH and 1.35 molar in PAH repeat units.

3. AHTL was dissolved in RO water to yield a 125 microliter aqueous solution that was 2.7 molar in AHTL.

4. The solution produced in step 3 was quickly added to the solution produced in step 2, and the mixture was vigorously agitated.

5. A bare QCM (International Crystal Manufacturing; overall dimensions, 0.538 inch diameter by 0.1 mm thickness; electrode specifications, 0.2 inch diameter by 100 nm thick gold circles concentrically deposited over 10 nm thick chromium on each face of the QCM; separately deposited gold leads connect the electrode circles to QCM's peripheral edge; nominal resonant frequency for the uncoated QCM, 10 MHz) was sequentially washed and air-dried with hexane, 2.7 M aqueous NaOH, and RO water.

6. The solution produced in step 4 was spin coated onto the QCM at 2000 rpm.

7. The QCM and its cast film were heated to 120° C. in an oven for 12 hours, cooled, rinsed with RO water, and dried in ambient air.

8. Dry film thickness was measured by contact profilometry. A thickness of 700 nm was obtained.

Testing Protocol of the Example PAH QCM Sensor:

The coated QCM was sealed in a custom flow cell by pressing an O-ring against the QCM's quartz periphery, and in this fashion, exposing only the coated site to the test stream; the sealing O-ring was well away from the coated electrode. Test solutions were driven at approximately 1 milliliter/minute through the flow cell's inlet and outlet ports, spanning an enclosed fluid volume of approximately 100 microliters. A solenoid valve manifold upstream of the flow cell permitted switching of inlet flow streams. When a coated QCM was first installed in the flow cell, a stream of 5 millimolar KCl in RO water was injected through the inlet port for 4 hrs. This stream put the PAH hydrogel into its fully protonated chloride form and allowed equilibrium swelling of the previously dry hydrogel coating. After 4 hrs, the QCM resonated at a stable frequency (approximately 9.998 MHz) somewhat below the resonant frequency of the bare QCM (approximately 10.00 MHz). Resonant frequencies were measured in the active mode using an inductor-compensated lever oscillator circuit. By this method, resonant frequency can be measured to an accuracy of better than ±10 Hz.

Testing Results of the Example PAH QCM Sensor:

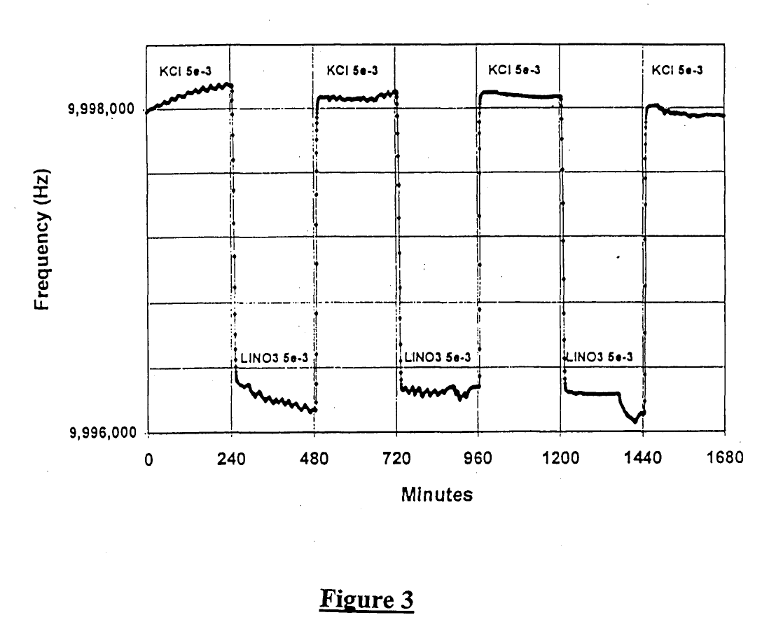

FIG. 3 is a graph showing the frequency response of the example PAH QCM sensor. To measure this response, the sensor was repetitively challenged in its chloride form by 4 hour exposures to flowing aqueous solutions containing 5 millimolar nitrate (indicated on the figure by the label “LINO3 5e-3”, reflecting nitrate present in the form of its dissolved lithium salt; this molarity corresponds to 300 PPM nitrate). With each challenge, the resonant frequency of the sensor dropped by approximately 1500 Hz, corresponding to conversion of the sensor to its nitrate form. Nitrate is a more massive anion than chloride (molecular weight 62.0 g/mol vs. 35.5 g/mol), so the frequency shift arises from a mass change of the coated hydrogel. Clearly, the nitrate ion exchanges for the chloride ion when the hydrogel is exposed to a nitrate solution; this exchange is expected from the affinity sequence for PAH. The frequency drop was reversed in each case when the challenging nitrate solution was withdrawn, being replaced by a solution containing 5 mM chloride (indicated on the figure by the label “KCL 5e-3”, reflecting chloride present in the form of its dissolved potassium salt; this molarity corresponds to 172 PPM chloride). The hydrogel in its chloride form has a lower mass than the hydrogel in its nitrate form, so the QCM resonates at a higher frequency.

Effects other than mass change of the hydrogel layer may be responsible for some of the measured frequency shift, and the invention does not rely on the frequency shift being solely attributable to the mass change of ion-exchanging counterions. An additional mechanism that may contribute to the frequency shift is preferential swelling/deswelling of hydrogel. Observation of insensitivity of QCM response to co-ion mass (co-ions are identified as solution ions of the same charge as the fixed ionic functionality of the hydrogel) and frequency shifts of increasing magnitude for more massive counterions suggest, but do not prove, that mass change is the principle mechanism of action for sensor response. QCM ion sensors prepared in the same fashion as the example but exposed to nitrate concentrations as low as 6 ppm produced clear frequency shifts with good signal-to-noise.

Alternative Embodiments:

A variety of similar hydrogels types and adhesion chemistries were examined, and many of these systems had valuable properties, although none performed as well in the application of QCM ion-sensing as the preferred embodiment of the invention. In other applications, these alternative embodiments may have superior properties. Additional embodiments have not been examined but directly follow from knowledge gathered in the course of the invention.

Alternative 1. Thiol-Functionalized, Ion-Capture Hydrogels.

Ion capture, sometimes termed chelation, and ion exchange are often not explicitly acknowledged as separate phenomena in the ion-exchange literature. The inventors differentiate the two to distinguish gels acting predominately by electrostatic interactions from those acting predominantly by specific, non-electrostatic interactions. Many commercial chelating resins incorporate thiol groups to capture heavy metals. For example, it is expected that the preferred PAH embodiment may be altered to produce ion-capture films for heavy metals simply by thiolating all of the amine functionality by the chemistry described in FIG. 1. At high levels of thiolation, PAH crosslinks itself via disulfide bond formation, and thus an added crosslinking agent may not be needed. Processing films of this type is possible because the thiolation and crosslinking occur concomitantly after spinning films from solution.

Among the chelating hydrogel functionalities that might prove useful in QCM ion sensors are pyridyls, bipyridyls, terpyridyls, enamines, poryphins, phenanthrolines, cryptands, cyclic ethers, vicinal alcohols, thiols, thiosulfates, thiocyanates, sulfides, cyclic sulfides, and ethylenediamine tetraacetic acid (EDTA). Many of these functionalities have been described in the literature concerned with metal recovery and chromatography.

Alternative 2. Composite Coatings.

In this embodiment, inert hydrogels and water-insoluble polymers are described as binders for encasing or otherwise attaching dispersed ion-exchanging media in composite coatings, enabling another class of QCM ion sensors. This class is distinguished by the coating's heterogeneous nature. In some instances, for example, chemical rigidity is needed in the vicinity of the ion exchange site to make the site more ion-selective. For high ion selectivity, therefore, composite coatings with dispersed ion exchange media may be preferred. The ready availability and diversity of commercial ion exchange resins enhances the attractiveness of composite coatings. Ion exchange media such as clay particles and zeolites may have desirable properties when used in this alternative form of the invention.

Hydrogels binders in the composite sensor approach combine the dimensional stability of a solid with the transport properties of a liquid, but a hydrophobic binder with a high loading of ion exchange material may also provide sufficient ion transport. In either case, ion permeability must be large enough to ensure that ions from a contacting solution can explore the coating in a reasonable time for sensing applications. Placement of thiols or sulfides in the binder may prevent debonding/delamination of the binder/ion-exchanger composite from the QCM surface. These and similar functionalities may also prevent debonding/cavitation of the binder from the ion exchange media.

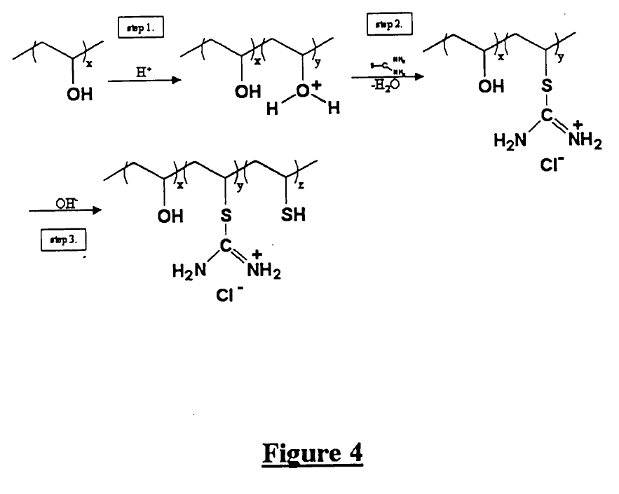

Thiolated poly (vinyl alcohol) was explored as an inert binder using the thiolation chemistry shown in FIG. 4. In this reaction chemistry, a precursor polymer possessing a small fraction of thiuronium groups is produced. The structure of the precursor polymer, in its thiuronium salt form, is shown as the product of the reaction's second step. After coating a gold surface with a mixture of precursor polymer and the desired ion exchange media, the thiuronium salt is hydrolyzed with base to form thiol groups, as illustrated by step 3. The thiols spontaneously react with the gold, adhering the ion-exchanging composite. Simultaneously, the base may gel the polyvinyl alcohol. Additional crosslinking, if needed, can be achieved by submerging the coated polyvinyl alcohol layer in an aqueous borate solution. The degree of thiolation needed for bonding the composite to the metal surface depends on many factors. However, adequate thiolation requires conversion of only a small percentage of the polymer's hydroxyl groups.

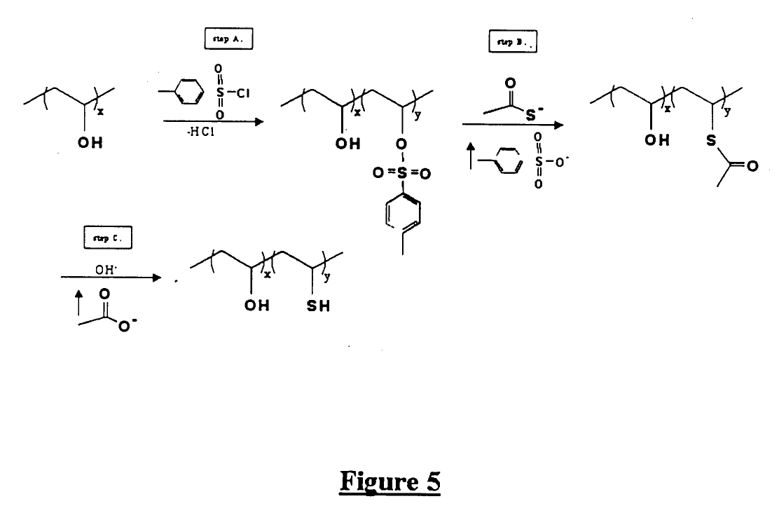

As shown in FIG. 5, treatment with tosyl chloride, thioacetate, and base provides an alternative route for thiolating hydroxyl-containing polymers such as polyvinyl alcohol. The thioester product of the reaction's second step can be admixed with ion exchange resin and spin coated on a gold surface. After coating, the thioester can be hydrolyzed with base to yield the thiol. Once again, crosslinking occurs as the thiols establish bonds with a metal surface.

Drawbacks to composite hydrogel coatings noted by the inventors are limited control over film thickness and difficulty preparing coatings thin enough to give optimized QCM response. The impact of hydrogel coating thickness on the sensitivity of a QCM ion sensor made by the disclosed invention remains poorly understood. Superficially, a thicker film might seem to have a higher capacity and thus offer greater sensitivity. The inventors have found, however, that films thinner than 1 micron (when, dry) work much better than those that are thicker. This trend possibly can be explained in terms of the penetration depth (decay length) of shear waves into the hydrogel coating; QCM response relies on the propagation of shear waves from the electrode into the coating. In the literature, the penetration depth is generally assumed to be less than 1.0 micron for a fluid-like medium such as water. For a hydrogel penetration is greater to some unknown extent that depends on the hydrogel's complex mechanical properties. Portions of the hydrogel further from the electrode surface than the penetration depth do not positively contribute to QCM response. Indeed, our observation of poor response in thick films strongly suggests that these portions have a significant negative contribution, perhaps dampening the desired oscillations nearer to the electrode surface. Currently, ion-exchange particles (and other dispersed solid ion exchange media) smaller than approximately 10 microns are not readily available, and in their absence, liquid state processing to make coatings thinner than 10 microns is precluded.

Alternative 3. Cyclic Sulfides for Thiolation of Amine-Containing Hydrogels.

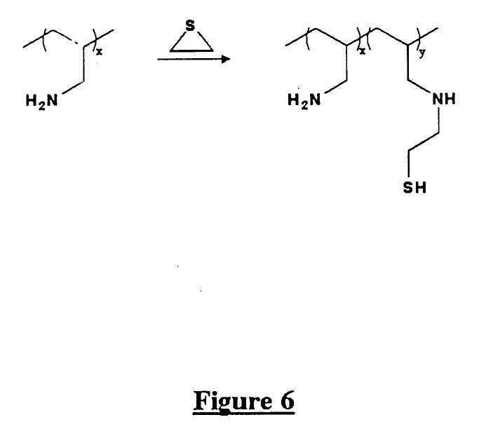

The reaction of PAH with cyclic sulfides to form thiols and sulfides outlines a possible path for making gold-adherent ion-exchanging gels. A schematic of this strategy is shown in FIG. 6. For simplicity, the concomitant formation of the oligo(ethylene sulfide) side chains is not shown. Other cyclic sulfides may be used in place of ethylene sulfide.

Alternative 4. Surface Prefunctionalization.

In this alternative embodiment of the invention, adhesion of a hydrogel coating is attained by prefunctionalization of a metal surface with a monolayer of a thiol or sulfide compound that promotes hydrogel adhesion. The bridging of a hydrogel to metal by these sulfur-containing monolayers can be either covalent or physical. In the latter case, hydrogen-bonding, ionic bonding, chain entanglements, and similar noncovalent interactions between hydrogel and bridging compound promote adhesion of the hydrogel to the metal. The bonding of sulfur-containing compounds to coinage-family metals is well known, but methods exploiting monolayers of such compounds for the attachment of hydrogels to metal surfaces have not been reported.

To create poly(vinyl alcohol) hydrogel coatings on gold, three adhesion promoting compounds have been tested, 3-mercaptopropionic acid, 16-mercaptohexadecanoic acid, and 3-thiophene boronic acid. The structures of adsorbed molecules of the first two are shown in FIG. 10. Poly(vinyl alcohol) hydrogels can hydrogen bond to the acids of the adhesion-promoting compounds shown in FIG. 10, anchoring the hydrogels to the metal surface. The binding of thiophenes to gold is not shown in the same figure because, although the binding is known, the mechanism of this binding is not understood. The ability of boronic acid-substituted compounds to interact with poly(vinyl alcohol) is known. In cases where functionalization of the gelling material is difficult, the surface functionalization approach may be more appropriate.

Alternative 5. Alkylated Hydrogels.

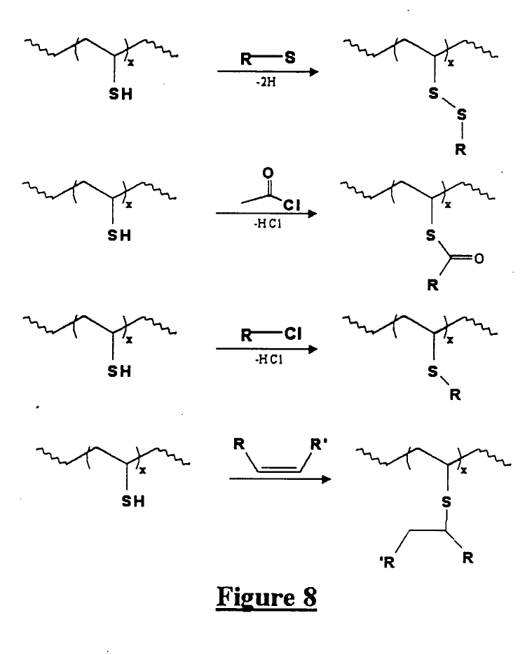

Reaction of a thiolated hydrogel with alkyl halides, as shown in FIG. 8, can be performed to enhance ion specificity or expand the working pH range of a hydrogel-coated QCM sensor. The reaction product shown in the figure is a quaternary amine, but secondary and tertiary amines may also be produced by this sort of reaction. Ion specificity varies with the chemical identity and number of R group(s) incorporated by the alkylation reaction. Ion exchange is made essentially pH independent when the reaction product is a quaternary amine. Insensitivity to pH will be an extremely important coating property in QCM ion sensors used to detect ions in liquids of uncontrolled pH.

Alternative 6. Protection of the Thiol Group.

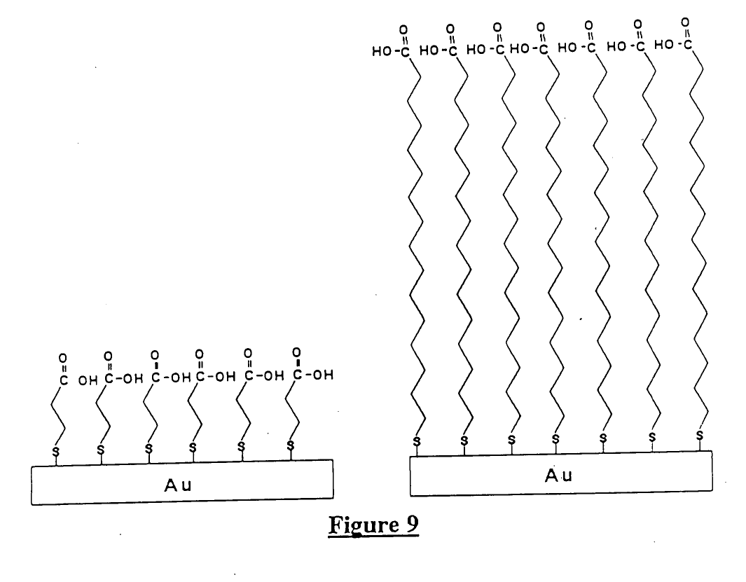

Chemical protection of the thiol group may be necessary during processing to prevent crosslinking For example, the chemistry for thiolating hydroxyl-containing polymers shown in FIGS. 4 and 5 has the advantage that thiols are not formed directly, preventing premature gelation due to disulfide formation; premature gelation would disallow liquid-state coating processes. Several protection methods able to prevent premature disulfide crosslinking of thiol-containing polymers are shown in FIG. 9.

Advantages of the Disclosed Method over Prior Art

The disclosed invention differs markedly from any prior art but can be contrasted to two studies that report similar QCM coating methods:

Chance and Purdy. Chance and Purdy reported sensors based on commercial, crosslinked polystyrene ion-exchange particles directly adsorbed to a QCM. Their sensor target, an antibiotic, was very large, with a molecular weight more than 50 times larger than our target, small ions. It should also be noted that the coatings reported by Chance and Purdy were not formed on the QCM electrode, as disclosed herein, but rather were physically adhered to the electrode as solid particles. Details of the mechanism by which the antibiotic was detected in Chance and Purdy's study were not reported and probably much different than those described here. Chance and Purdy did not mention the ion exchange properties of their coatings, and these coatings were not hydrogels. The films of the present invention are nominally 140 times thinner than those reported by Chance and Purdy, and the chemistries described here are completely different.

Kanekiyo et al. Kanekiyo et al. synthesized molecularly imprinted hydrogel coatings for QCM sensors. In one instance, their hydrogel exploited a disulfide compound for both crosslinking and adhesion. Unlike the disclosed invention, to form the QCM coating, the hydrogel was preformed (i.e., gelled in bulk), dried, thinly sliced, and adhered to the QCM electrode under vacuum. The nature of the obtained adhesion was not clearly identified. Processing preformed materials of this type, much as with the ion exchange particles of Chance and Purdy, has numerous disadvantages compared to the disclosed invention. As noted before, hydrogel thicknesses are larger than desired, adhesion is not strong or well controlled, and processing is laborious and irreproducible. The sensing mechanism described by Kanekiyo et al., molecular imprinting, departs from those here described.

The illustrated embodiments of the invention are intended to be illustrative only, recognizing that persons having ordinary skill in the art may construct different forms of the invention that fully fall within the scope of the subject matter disclosed herein.

What is claimed is:

1. A method for robustly coating a polymeric hydrogel onto a metal surface. The method entails three basic steps: application to the surface of a liquid mixture, gelling of this mixture to form a hydrogel network, and chemisorption of this network to the surface. The solidification and chemisorption steps proceed concurrently.

2. A sensor employing a coating described in claim 1 to provide sensitivity and/or selectivity to a target substance.
